(19) United States
(12) Patent Application Publication
(10) Pub. No.: US 2024/0413365 A1
(43) Pub. Date: Dec. 12, 2024

(54) METHOD

(71) Applicant: JOHNSON MATTHEY HYDROGEN TECHNOLOGIES LIMITED, London (GB)

(72) Inventors: Jake COOLE, Swindon Wiltshire (GB); Angus DICKINSON, Swindon Wiltshire (GB); Julie O'SULLIVAN, Swindon Wiltshire (GB)

(21) Appl. No.: 18/702,013

(22) PCT Filed: Dec. 8, 2022
(86) PCT No.: PCT/GB2022/053129

§ 371 Date: Apr. 17, 2024

(30) Foreign Application Priority Data
Dec. 8, 2021 (GB) 2117684.7

(51) Int. Cl. H01M 8/1004; C25B 9/23; H01M 8/10

(52) U.S. Cl. CPC H01M 8/1004; C25B 9/23; H01M 2008/1095

(57) ABSTRACT

According to the present invention, there is provided a method of manufacturing a catalyst-coated ion-conducting membrane, the method comprising the steps of: (a) providing a catalyst layer on a backing layer, wherein the catalyst layer comprises pores; (b) applying a wetting solution to the catalyst layer, wherein the wetting solution impregnates at least some of the pores of the catalyst layer so as to form a wetted catalyst surface; (c) depositing a first dispersion onto the wetted catalyst surface to form a first dispersion layer on the wetted catalyst surface, wherein the first dispersion comprises an ion-conducting polymer; and (d) drying the first dispersion layer and the wetted catalyst surface after step (c).

### FIELD OF THE INVENTION

This invention relates to a method of manufacturing a catalyst coated ion-conducting membrane. In particular, this invention relates to a method of manufacturing a catalyst coated ion-conducting membrane for an electrochemical device, such as a fuel cell or an electrolyser. This invention also relates to associated methods of manufacturing a membrane-seal assembly and a membrane electrode assembly.

### BACKGROUND OF THE INVENTION

A fuel cell is an electrochemical cell comprising two electrodes separated by an electrolyte. A fuel, such as hydrogen or an alcohol, such as methanol or ethanol, is supplied to the anode and an oxidant, such as oxygen or air, is supplied to the cathode. Electrochemical reactions occur at the electrodes, and the chemical energy of the fuel and the oxidant is converted to electrical energy and heat. Electrocatalysts are used to promote the electrochemical oxidation of the fuel at the anode and the electrochemical reduction of oxygen at the cathode.

In the hydrogen-fueled or alcohol-fueled proton exchange membrane fuel cells (PEMFC), the electrolyte is a solid polymeric membrane, which is electronically insulating and proton conducting. Protons, produced at the anode, are transported across the membrane to the cathode, where they combine with oxygen to form water. The most widely used alcohol fuel is methanol, and this variant of the PEMFC is often referred to as a direct methanol fuel cell (DMFC).

The principal component of the PEMFC is known as a membrane electrode assembly (MEA) and is essentially composed of five layers. The central layer is the polymeric ion-conducting membrane. On either side of the ion-conducting membrane there is an electrocatalyst layer, containing an electrocatalyst designed for the specific electrocatalytic reaction. The electrocatalyst layer is electrically conducting. Finally, adjacent to each electrocatalyst layer there is a gas diffusion layer. The gas diffusion layer must allow the reactants to reach the electrocatalyst layer and must conduct the electric current that is generated by the electrochemical reactions. Therefore the gas diffusion layer must be porous and electrically conducting.

Conventionally, the MEA can be constructed by a number of methods outlined hereinafter:
(i) The electrocatalyst layer may be applied to the gas diffusion layer to form a gas diffusion electrode. Two gas diffusion electrodes can be placed either side of an ion-conducting membrane and laminated together to form the five-layer MEA;
(ii) The electrocatalyst layer may be applied to both faces of the ion-conducting membrane to form a catalyst-coated ion-conducting membrane. Subsequently, gas diffusion layers are applied to both faces of the catalyst-coated ion-conducting membrane.
(iii) An MEA can be formed from an ion-conducting membrane coated on one side with an electrocatalyst layer, a gas diffusion layer adjacent to that electrocatalyst layer, and a gas diffusion electrode on the other side of the ion-conducting membrane.

Known construction methods typically require heating the ion-conducting membrane above its glass transition temperature (T_{g}), which can cause defects in the product. It is desirable to develop an efficient method which can reduce the prevalence of defects during manufacture.

Such MEAs also have applications in other electrochemical devices, such as electrolysers. Electrolysis of water, to produce high purity hydrogen and oxygen, can be carried out in both alkaline and acidic electrolyte systems using an electrolyser. Acidic electrolyte systems typically employ a solid proton-conducting polymer electrolyte membrane and are known as polymer electrolyte membrane water electrolysers (PEMWEs). A catalyst-coated ion-conducting membrane is employed within the cell of a PEMWE, which comprises the (ion-conducting) polymer electrolyte membrane with two catalyst layers (for the anode and cathode reactions respectively) applied on either face of the polymer electrolyte membrane. To complete the electrolysis cell, current collectors, which are typically metal meshes, are positioned either side of the catalyst-coated ion-conducting membrane. MEAs used in electrolysers can be manufactured using similar processes to those described above for fuel cells and are susceptible to the same problems.

### SUMMARY OF THE INVENTION

To facilitate commercialisation of electrochemical devices, such as fuel cells and electrolysers, it is desirable to improve the speed of manufacture of the catalyst-coated ion-conducting membrane. This will increase the manufacturing rate of the catalyst-coated ion-conducting membrane or membrane electrode assembly, and improve manufacturing capacity and device throughput.

It is also desirable to develop a method in which the interface between the catalyst layer and the ion-conducting membrane is improved.

The present invention, in at least some of its embodiments, seeks to address at least some of the above described problems, desires and needs. For example, the present invention provides a method of manufacturing a catalyst-coated ion-conducting membrane with an improved interface between the catalyst layer and the ion-conducting membrane.

According to a first aspect of the invention, there is provided a method of manufacturing a catalyst-coated ion-conducting membrane, the method comprising the steps of:
(a) providing a catalyst layer on a backing layer, wherein the catalyst layer comprises a pores;
(b) applying a wetting solution to the catalyst layer, wherein the wetting solution impregnates at least some of the pores of the catalyst layer so as to form a wetted catalyst surface;
(c) depositing a first dispersion onto the wetted catalyst surface to form a first dispersion layer on the wetted catalyst surface, wherein the first dispersion comprises an ion-conducting polymer; and
(d) drying the first dispersion layer and the wetted catalyst surface after step (c).

Wetting the catalyst layer prior to depositing the first dispersion can surprisingly improve the interface between the catalyst layer and the ion-conducting membrane when the layers are dried. Without wishing to be bound by any particular theory or conjecture, it is believed that wetting the catalyst layer substantially prevents the first dispersion from impregnating the pores of the catalyst layer. Consequently, the concentration of ion-conducting polymer in the catalyst layer remains substantially the same. Additionally, unwanted reactions between the catalyst in the catalyst layer and the ion-conducting polymer in the first dispersion are suppressed and the formation of unwanted side products (e.g. bubbles) is reduced. This can lead to a more reliable manufacturing process with fewer defective products.

According to a second aspect, there is provided a method of manufacturing a membrane-seal assembly, the method comprising the steps of:
providing a catalyst-coated ion-conducting membrane manufactured using the method according to the first aspect, the catalyst-coated ion-conducting membrane comprising a first face and a second face; and
applying a seal material to the first face and/or the second face of the catalyst-coated ion-conducting membrane.

According to a third aspect, there is provided a method of manufacturing a membrane electrode assembly, the method comprising the steps of:
providing a catalyst-coated ion-conducting membrane manufactured using the method according to the first aspect, the catalyst-coated ion-conducting membrane comprising a first face and a second face; and
applying a gas diffusion layer onto the first and/or second faces of the catalyst-coated ion-conducting membrane.

According to a fourth aspect, there is provided a method of manufacturing a membrane electrode assembly, the method comprising the steps of:
providing a membrane-seal assembly manufactured according to the method according to the second aspect, the membrane-seal assembly comprising a first face and a second face; and
applying a gas diffusion layer onto the first and/or second faces of the membrane seal assembly.

According to a fifth aspect, there is provided a catalyst-coated ion-conducting membrane obtainable using the method of the first aspect.

Whilst the invention has been described above, it extends to any inventive combination of the features set out above, or in the following description, drawings or claims. For example, any features disclosed in relation to one aspect of the invention may be combined with any feature of another aspect of the invention.

### BRIEF DESCRIPTION OF THE DRAWINGS

Embodiments of the invention will now be described, by way of example only, with reference to the accompanying drawings, in which:

FIG. 1 illustrates an exemplary method according to an embodiment of the present invention;

FIG. 2 is a schematic illustration of a slot die printing process;

FIGS. 3 to 5 illustrate exemplary methods according to embodiments of the present invention;

FIG. 6 is a representation of a deposition process in which the first and second dispersions are deposited concurrently;

FIG. 7 shows a second layer on top of a first layer, wherein the density of the second layer is less than the density of the first layer;

FIG. 8 shows a second layer on top of a first layer, wherein the second layer has a lower concentration of ion-conducting polymer than the first layer;

FIG. 9 shows a second layer on top of a first layer, wherein the density of the second layer is less than the density of the first layer.

### DETAILED DESCRIPTION OF THE INVENTION

The invention provides a method of manufacturing a catalyst coated ion-conducting membrane. The catalyst-coated ion-conducting membrane can be a catalyst-coated proton-exchange membrane. The catalyst-coated ion-conducting membrane can be suitable for an electrochemical device, such as a fuel cell or an electrolyser. The method comprises the steps of:
(a) providing a catalyst layer on a backing layer, wherein the catalyst layer comprises pores;
(b) applying a wetting solution to the catalyst layer so as to form a wetted catalyst surface;
(c) depositing a first dispersion onto the wetted catalyst surface to form a first dispersion layer on the wetted catalyst surface, wherein the first dispersion comprises an ion-conducting polymer; and
(d) drying the first dispersion layer and the wetted catalyst surface after step (c).

It will be clear to the skilled person that many variations of the above basic process are possible, some of which are described in more detail below with reference to the figures. However, all such variations, whether explicitly described or not, are within the scope of the invention.

The term “dispersion” as used here means a system in which a dispersed phase (e.g. solid particles) is dispersed in a (liquid) continuous phase. The dispersed phase comprises the ion-conducting polymer. The ion-conducting polymer is dispersed in the continuous phase. The continuous phase comprises one or more solvents.

Depositing a first dispersion onto a wetted catalyst surface to form a discrete first dispersion layer, can unexpectedly help to provide an improved interface between the catalyst layer and the ion-conducting membrane when the layers are dried. Additionally, unwanted reactions between the catalyst in the catalyst layer and the ion-conducting polymer in the first dispersion are suppressed and the formation of unwanted side products (e.g. bubbles) is reduced. This can lead to a more reliable manufacturing process with fewer defective products.

### Wetting Solution

Step (b) typically comprises depositing the wetting solution onto the catalyst layer so that the wetting solution coats and/or impregnates the pores of the catalyst layer. The wetting solution can be deposited onto the catalyst layer by spray coating, slot-die (slot, extrusion) coating (whereby the dispersion is squeezed out by gravity or under pressure via a slot onto the substrate), knife-coating, bar coating, inkjet printing, gravure printing, curtain coating, or dip coating. Preferably, the wetting solution is deposited onto the catalyst layer by a spray coating process or a slot-die coating process.

The surface of the catalyst layer comprises pores. The pores extend across an area of the catalyst layer surface (i.e. across an xy plane). The wetting solution can impregnate a proportion of the total number of the pores at the surface of the catalyst layer. For example, the wetting solution can impregnate at least 70%, preferably at least 80%, and more preferably at least 90% of the pores at the surface of the catalyst layer. Most preferably, the wetting solution impregnates all the pores at the surface of the catalyst layer.

The wetting solution impregnates the pores across a proportion or all of the (geometric) area of the catalyst layer. For example, the wetting solution can impregnate the pores across at least 70%, preferably at least 80%, and more preferably at least 90% of the (geometric) area of the catalyst layer. Most preferably, the wetting solution can impregnate substantially all of the pores across the full (geometric) area of the catalyst layer. Put another way, the wetted catalyst surface can have a (geometric) area that is at least 70%, preferably at least 80%, more preferably at least 90%, and most preferably about 100% of the (geometric) area of the catalyst layer.

The pores of the catalyst layer typically extend through the full thickness of the catalyst layer (i.e. in a z direction). The wetting solution can impregnate the pores across a proportion of the thickness of the catalyst layer. For example, the wetting solution can impregnate the pores to a depth of 50% or less, preferably, 30% or less, or more preferably about 20% or less, of the (through-plane) thickness of the catalyst layer. This can be determined using high angle annular dark field (HAADF) imaging. Wetting only a proportion of the thickness of the catalyst layer near to the catalyst surface can facilitate removing the wetting solution from the catalyst layer during the drying step. Alternatively, the full thickness of the catalyst layer can be saturated by the wetting solution.

An excess amount of wetting solution can be provided onto the catalyst layer. The wetting solution can form a layer of wetting solution on top of the catalyst layer. Where the wetting solution forms a layer of wetting solution on top of the catalyst layer, the method can further comprise the step of at least partially (or fully) removing the layer of wetting solution, preferably whilst retaining the wetting solution within the pores, prior to the step of depositing the first dispersion. The layer of wetting solution can be removed using an air knife, for example, without drying the wetted porous surface.

The wetting solution can comprise, consist essentially of, or consist of water, a polar solvent (other than water), or a mixture of water and a polar solvent other than water. The polar solvent can be a polar protic solvent. Preferably, the polar solvent is an alcohol, more preferably a C₁₋₄ alcohol. The C₁₋₄ alcohol can be methanol, ethanol, propan-1-ol, isopropyl alcohol, n-butanol, iso-butanol, butan-2-ol, and tert-butyl alcohol, or a mixture thereof. Preferably, the C₁₋₄ alcohol is ethanol, propan-1-ol, or isopropyl alcohol. Most preferably, the C₁₋₄ alcohol is ethanol. Preferably, the wetting solution is selected from: water and methanol; water and ethanol; water and propan-1-ol; and water and isopropyl alcohol. Most preferably, the wetting solution is a mixture of ethanol and water. Suitably, the wetting solution is substantially devoid of (and preferably does not comprise) an ion-conducting polymer, such as a proton conducting polymer.

Preferably, the wetting solution comprises the polar solvent other than water (e.g. C₁₋₄ alcohol) in an amount in the range of >70 wt. %, preferably 75-90 wt. %, or more preferably 80-85 wt. % based on the total weight of the wetting solution. The wetting solution can comprise the polar solvent other than water (e.g. C₁₋₄ alcohol) in any combination of the limits of these ranges. A high alcohol content in the wetting solution helps the wetting solution to spontaneously wet the porous surface of the catalyst layer. A high alcohol content in the wetting solution also helps to reduce the surface tension of the wetting solution, which can further help the wetting solution to have a high degree of wetting towards the catalyst layer.

The “degree of wetting” (also referred to as “wettability”) is a measure of how well a liquid wets (i.e. spreads across) a surface. The degree of wetting can be determined by measuring the contact angle of a liquid on a surface. Contact angles can be measured using known techniques, such as using a contact angle meter at room temperature. For example, contact angles can be measured using a PCA-11 contact angle meter, which is commercially available from Kyowa Interface Science Co., Ltd. of Saitama, Japan. A higher contact angle (up to 180°) corresponds to a lower degree of wetting. A lower contact angle corresponds to a higher degree of wetting.

The wetting solution typically has a high degree of wetting towards the catalyst layer. This can assist the wetting solution to impregnate the pores of the catalyst layer, and can help to form the wetted catalyst surface. For example, the wetting solution can have a contact angle of <90° towards the catalyst layer, when measured using a contact angle meter at a temperature of 25° C. Preferably, the wetting solution fully wets the catalyst layer.

The wetting solution can comprise water in an amount in the range of <30 wt. %, preferably 10-25 wt. %, and more preferably 15-20 wt. %. The wetting solution can comprise water in any combination of the limits of these ranges.

The wetting solution can have a higher degree of wetting towards the catalyst layer than the first dispersion. However, this is not essential. The first dispersion can be wetting or non-wetting towards the wetted catalyst layer. For example, the first dispersion can have a contact angle of >90° towards the wetted catalyst surface, when measured using a contact angle meter at a temperature of 25° C. Preferably, the first dispersion has a contact angle of <90° towards the wetted catalyst surface, when measured using a contact angle meter at a temperature of 25° C.

The surface tension of the first dispersion can be sufficiently low to wet the wetted catalyst surface. For example, the first dispersion can have a surface tension of less than 38 mN/m, preferably less than 28 mN/m, and more preferably less than 24 mN/m, when measured at 25° C. Surface tension can be measured using a tensiometer employing the Wilhelmy plate principle, as described in Vázquez, G et al., J. Chem, Eng. Data, 1995, 40, 611-614.

Without wishing to be bound by any theory or conjecture, it is believed that wetting the catalyst layer with the wetting solution substantially prevents the first dispersion from penetrating into the pores of the catalyst layer. Consequently, the first (ionomer) dispersion can have a low surface tension and exhibit a high degree of wetting towards the catalyst layer, without penetrating into the pores of the catalyst layer. The first dispersion can be deposited on top of the wetted catalyst surface of the catalyst layer without penetrating into the pores of the catalyst layer. Consequently, unwanted reactions between the first dispersion and the catalyst in the catalyst layer can be avoided. In this way, an improved interface between the catalyst layer and the ion-conducting membrane can be achieved.

The step of drying the wetted catalyst surface suitably comprises removing substantially all (and preferably all) of the wetting solution from the catalyst layer (e.g. from the pores of the catalyst layer). Typically, the wetted catalyst surface and the first dispersion layer are dried simultaneously. The first dispersion layer and the wetted catalyst surface can be dried at a temperature in the range of 50-100° C., preferably 60-80° C.

### First Dispersion

The first dispersion comprises a continuous phase comprising one or more solvents. The first dispersion can comprise a continuous phase comprising (or consisting of) water, a polar solvent (other than water), or (preferably) a mixture of water and a polar solvent (other than water). The polar solvent can be a polar protic solvent. Preferably, the polar solvent is an alcohol, more preferably a C₁₋₄ alcohol. The C₁₋₄ alcohol can be methanol, ethanol, propan-1-ol, propan-2-ol, n-butanol, iso-butanol, butan-2-ol, and tert-butyl alcohol, or a mixture thereof. Preferably, the C₁₋₄ alcohol is ethanol and/or propan-1-ol. Preferably, the continuous phase comprises (or consists essentially of) water and an alcohol. More preferably, the continuous phase comprises (or consists essentially of) water and at least one of ethanol or propan-1-ol. Most preferably, the continuous phase comprises (or consists essentially of) water and ethanol.

The continuous phase of the first dispersion can comprise a polar solvent other than water (e.g. C₁₋₄ alcohol) in an amount (in wt. % based on the total weight of the continuous phase of the first dispersion) that is less than the amount of polar solvent other than water (e.g. C₁₋₄ alcohol) in the wetting solution (in wt. % based on the total weight of the wetting solution). For the avoidance of doubt, it is preferable that:

$$\frac{Weight of polar solvent in first dispersion}{Total weight of cont . phase of first dispersion} <$$

$$\frac{Weight of polar solvent in wetting soln .}{Total weight of wetting soln .}$$

The continuous phase of the first dispersion can comprise water in an amount (in wt. % based on the total weight of the continuous phase of the first dispersion) that is more than the amount of water in the wetting solution (in wt. % based on the total weight of the wetting solution).

The continuous phase of the first dispersion can comprise the polar solvent other than water (e.g. C₁₋₄ alcohol) in an amount in the range of <90 wt. %, preferably 10-85 wt. %, or more preferably 20-80 wt. % based on the total weight of the continuous phase. In some embodiments, the continuous phase of the first dispersion can comprise the polar solvent other than water (e.g. C₁₋₄ alcohol) in an amount in the range of <70 wt. %, preferably 10 wt. % to 50 wt. %, and more preferably 20 wt. % to 40 wt. %. The continuous phase can comprise the polar solvent other than water (e.g. C₁₋₄ alcohol) in any combination of the limits of these ranges. Unless explicitly stated otherwise, the upper and lower limits of all numerical ranges disclosed in this application are included within the range.

The continuous phase of the first dispersion can comprise water in an amount in the range of >10 wt. %, preferably 15-90 wt. %, and more preferably 20-80 wt. %. The continuous phase can comprise water in any combination of the limits of these ranges.

The first dispersion comprises an ion-conducting polymer, which is dispersed in the continuous phase. The ion-conducting polymer can be a proton-conducting polymer or an anion-conducting polymer, such as a hydroxyl anion-conducting polymer. Examples of suitable proton-conducting polymers include perfluorosulphonic acid ionomers (e.g. Nafion® (E.I. DuPont de Nemours and Co.), Aciplex® (Asahi Kasei), Aquivion™ (Solvay Speciality Polymers), Flemion® (Asahi Glass Co.), or ionomers based on a sulphonated hydrocarbon such as those available from FuMA-Tech GmbH as the Fumapem® P, E or K series of products, JSR Corporation, Toyobo Corporation, and others. Examples of suitable anion-conducting polymers include A901 made by Tokuyama Corporation and Fumasep FAA from FuMA-Tech GmbH.

The first dispersion can comprise the ion-conducting polymer in an amount in the range of 5-80 wt. %, preferably 10-50 wt. %, preferably 15-30 wt. %, and most preferably 15-20 wt. % based on the total weight of the first dispersion. The first dispersion can comprise the ion-conducting polymer in any combination of the limits of these ranges. For example, the first dispersion can comprise the ion-conducting polymer in an amount in the range 10-20 wt. %.

The first dispersion is an ion-conducting membrane precursor. When dried, the first dispersion forms a (first) ion-conducting membrane layer. The ion-conducting membrane layer is suitably electrically insulating. The ion-conducting membrane layer can be for (part of) the electrolyte of a fuel cell or electrolyser (i.e. an electrolyte membrane layer).

The first dispersion can further comprise one or more additives such as a hydrogen peroxide decomposition catalyst, a radical decomposition catalyst (such as ceria), and/or a recombination catalyst.

Hydrogen peroxide decomposition catalysts are known in the art, and may be selected from the group consisting of metal oxides, such as cerium oxides, manganese oxides, titanium oxides, beryllium oxides, bismuth oxides, tantalum oxides, niobium oxides, hafnium oxides, vanadium oxides and lanthanum oxides, suitably cerium oxides, manganese oxides or titanium oxides, preferably cerium dioxide (ceria).

A recombination catalyst catalyses the reaction of H₂ and O₂ to form H₂O. Suitable recombination catalysts can comprise a metal (such as platinum) on a high surface area oxide support material (such as silica, titania, or zirconia). More examples of recombination catalysts are disclosed in EP0631337 and WO00/24074. The catalyst is suitably dispersed in the continuous phase.

The first dispersion can be deposited using a slot-die (slot, extrusion) coating process (whereby the dispersion is squeezed out by gravity or under pressure via a slot onto the substrate), knife-coating, bar coating, inkjet printing, gravure printing, curtain coating, or a spray coating process. Preferably, the first dispersion can be deposited using slot-die coating, knife coating, bar coating, inkjet printing or gravure printing. These exemplar techniques can substantially avoid mixing between the first dispersion and the wetted catalyst surface of the catalyst layer. The wetting solution and the first dispersion can be deposited using the same or different techniques. Preferably, first dispersion is deposited using a slot-die coating process.

The step of drying the first dispersion layer suitably comprises removing substantially all (and preferably all) of the continuous phase from the first dispersion layer. The dried first dispersion layer is suitably a layer of an ion-conducting membrane.

### Further Layers

Any number of additional layers can be provided on top of the first dispersion layer prior to performing the step of drying the first dispersion layer and the wetted catalyst surface. For example, one, two, three or more additional dispersions comprising an ion-conducting polymer can be successively deposited onto the first dispersion layer prior to step (d). The additional dispersions are suitably ion-conducting membrane precursors, which dry to form additional ion-conducting membrane layers. Optionally or additionally, a catalyst layer dispersion can be deposited and dried to form a second catalyst layer. Where additional ion-conducting membrane layers and a second catalyst layer are provided, the additional ion-conducting membrane layers are suitably disposed between the first dispersion layer and the second catalyst layer. For example, the method can further comprise the step of:
(e) depositing a second dispersion onto the first dispersion to form a second dispersion layer on the first dispersion layer,
wherein step (d) comprises drying the first and second dispersion layers and the wetted catalyst surface after step (e).

The second dispersion suitably comprises an ion-conducting polymer, such as a proton conducting polymer.

The second dispersion can comprise a continuous phase comprising water, a polar solvent other than water, or a mixture thereof. The polar solvent other than water can be a polar protic solvent. Preferably, the polar solvent is an alcohol, more preferably a C₁₋₄ alcohol. The C₁₋₄ alcohol can be methanol, ethanol, propan-1-ol, propan-2-ol, n-butanol, iso-butanol, butan-2-ol, and tert-butyl alcohol, or a mixture thereof. Preferably, the C₁₋₄ alcohol is ethanol and/or propan-1-ol. Preferably, the continuous phase comprises (or consists essentially of) water and a C₁₋₄ alcohol. More preferably, the continuous phase comprises (or consists essentially of) water and at least one of ethanol or propan-1-ol. Most preferably, the continuous phase comprises (or consists essentially of) water and ethanol.

The continuous phase of the second dispersion can comprise a polar solvent other than water (e.g. C₁₋₄ alcohol) in a higher percent by weight than the continuous phase of the first dispersion, based on the total weight of the respective continuous phase.

The continuous phase of the second dispersion can comprise water in a lower percent by weight than the continuous phase of the first dispersion, based on the total weight of the respective continuous phase.

The continuous phase of the second dispersion can comprise the polar solvent other than water (e.g. C₁₋₄ alcohol) in an amount in the range of 50-100 wt. %, preferably 60-90 wt. %, or most preferably 70-80 wt. % based on the total weight of the continuous phase.

The continuous phase of the second dispersion can comprise water in an amount in the range of 0-50 wt. %, preferably 10-40 wt. %, and most preferably 20-30 wt. % based on the total weight of the continuous phase. The continuous phase can comprise water and the polar solvent other than water (e.g. C₁₋₄ alcohol) in any combination of these ranges.

The second dispersion comprises an ion-conducting polymer, which is dispersed in the continuous phase. The ion-conducting polymer can be a proton-conducting polymer or an anion-conducting polymer, such as a hydroxyl anion-conducting polymer. Examples of suitable proton-conducting polymers include perfluorosulphonic acid ionomers (e.g. Nafion® (E.I. DuPont de Nemours and Co.), Aciplex® (Asahi Kasei), Aquivion™ (Solvay Speciality Polymers), Flemion® (Asahi Glass Co.), or ionomers based on a sulphonated hydrocarbon such as those available from FuMA-Tech GmbH as the Fumapem® P, E or K series of products, JSR Corporation, Toyobo Corporation, and others. Examples of suitable anion-conducting polymers include A901 made by Tokuyama Corporation and Fumasep FAA from FuMA-Tech GmbH. The ion-conducting polymer of the first and second dispersions can be the same or different.

The second dispersion can comprise the ion-conducting polymer in an amount in the range of 5-80 wt. %, preferably 10-50 wt. %, preferably 15-30 wt. %, and preferably 15-20 wt. % based on the total weight of the second dispersion. The second dispersion can comprise the ion-conducting polymer in any combination of the limits of these ranges. For example, the second dispersion can comprise the ion-conducting polymer in an amount in the range 10-20 wt. %. The first and second dispersions can comprise an ion-conducting polymer in substantially the same or different percent by weight based on the total weight of the respective dispersion.

The first and second dispersions can be deposited concurrently. That is, the first dispersion can be deposited onto the wetted catalyst layer at the same time. Depositing the first and second dispersions concurrently can significantly increase manufacturing efficiency, manufacture speed, and hence can significantly increase manufacture capacity and throughput. Additionally, fewer discrete drying and/or heating steps are required, which can further help to reduce damage to the catalyst-coated ion-conducting membrane.

The first and second dispersions can independently be deposited using a slot-die (slot, extrusion) coating process, knife-coating, bar coating, inkjet printing, gravure printing, curtain coating, or a spray coating process. These exemplar techniques can substantially avoid mixing between the first and second dispersions. The first and second dispersions can be deposited using the same or a different technique. Preferably, the first and second dispersions are deposited using a slot-die coating process. More preferably, the first and second dispersions are deposited using a dual slot-die coating process. The slot-die coating process can comprise providing a slot die head comprising a first outlet and a second outlet. The first dispersion can be deposited onto the catalyst layer via the first outlet. The second dispersion can be deposited onto the first dispersion via the second outlet. Slot die coating (or dual slot die coating) can provide a suitable method for depositing the second dispersion onto the first dispersion whilst minimising turbulence, and hence minimising mixing, between the first and second layers.

In order for the first and second dispersions to form substantially discrete layers, the first and second dispersions typically have a different physical property, such as density. For example, one preferred method is to control the relative densities of the first and second dispersions. Preferably, the density of the first dispersion is greater than the density of the second dispersion. The density of the second dispersion can be at least 0.5%, preferably at least 1%, and more preferably at least 5%, less than the density of the first dispersion, when measured at 20° C. A lower density second dispersion can be deposited onto the first dispersion so that the second dispersion floats on top of the first dispersion. As such, the second dispersion forms a discrete second layer on the first layer. The first and second layers remain as discrete layers at least prior to the drying step. The layered structure of the first and second layers is retained on a timescale that is at least long enough for the drying step to be performed. The drying step is typically commenced less than 10 minutes, preferably less than 3 minutes, more preferably less than about 1 minute, and most preferably less than about 30 seconds, after the second dispersion has been deposited. The wetted catalyst surface, and the first and second dispersion layers can be dried simultaneously. The layers can be dried at a temperature in the range of and including 50° C. to 100° C., and preferably 60° C. to 80° C.

Another method is to control the viscosity of the first and second dispersions. For example, if the viscosity of the first and/or second dispersions is sufficiently high when the dispersions are deposited to form the first and second layers respectively, the rate of mixing between the first and second dispersions can be sufficiently slow so that the first and second layers remain as discrete layers at least prior to the drying step. That is, the layered structure of the first and second layers is retained on a timescale that is at least long enough for the drying step to be performed.

A further method is to control the relative concentrations of the ion-conducting polymer in the first and second dispersions. Preferably, the concentration of the ion-conducting polymer in the second dispersion is less than the concentration of the ion-conducting polymer in the first dispersion. In this way, a second dispersion can be deposited onto the first dispersion to form two discrete layers. The first and second layers can remain as discrete layers on a timescale that is at least long enough for the drying step to be performed.

Although the first and second dispersions form discrete layers, some mixing may occur at the interface between the first and second dispersions. Such mixing can form a blended layer at the interface. The blended layer comprises a mixture of the first and second dispersions. Preferably, the mixing between the first and second dispersions is minimal. The first and second dispersions remain as substantially discrete wet layers. Preferably, the first and second layers remain as substantially discrete layers when dried.

The first layer and the second layer form a layered structure. The layered structure can be metastable. For example, the layered structure can be disrupted if a suitably high shear force is applied.

The method can further comprise the steps of: depositing a catalyst dispersion, and drying the catalyst dispersion to form a second catalyst layer, wherein the first dispersion is disposed between the (first) catalyst layer (on the backing layer) and the second catalyst layer.

When dried, the catalyst-coated ion-conducting membrane can comprise an ion-conducting membrane comprising a first face coated with the (first) catalyst layer, and a second face coated with the second catalyst layer. Preferably, each catalyst layer is electronically conducting, and the ion-conducting membrane layer(s) is/are electrically non-conducting. The catalyst layers can be suitable for the anode and cathode of a fuel cell (or electrolyser) respectively. The ion-conducting membrane can be suitable for the electrolyte of a fuel cell or electrolyser (i.e. an electrolyte membrane).

### Catalyst Layer

Step (a) can further comprise the sub-steps of: depositing a catalyst dispersion on the backing layer; and drying the catalyst dispersion to form the catalyst layer. Preferably, the catalyst layer is electronically conducting. The catalyst layer comprises a catalyst. The catalyst layer is suitably for an electrode (e.g. anode or cathode) of a fuel cell or an electrolyser. The catalyst is suitably an electrocatalyst. The catalyst layer can comprise a conductive support, wherein the catalyst is supported on the conductive support. The catalyst can be a finely divided unsupported metal powder, or may be a supported catalyst wherein small metal nanoparticles are dispersed on an electrically conducting particulate carbon support. The electrocatalyst metal is suitably selected from:
(i) the platinum group metals (i.e. platinum, palladium, rhodium, ruthenium, iridium, and osmium),
(ii) gold or silver,
(iii) a base metal, or
(iv) an alloy or mixture comprising one or more of these metals or their oxides. The preferred electrocatalyst metal is platinum, which may be alloyed with other precious metals or base metals. If the electrocatalyst is a supported catalyst, the loading of metal particles on the carbon support material is suitably in the range 10-90 wt %, preferably 15-75 wt % of the weight of resulting electrocatalyst.

### Backing Layer

The method can further comprise the steps of removing the backing layer from the (first) catalyst layer after the step of drying the first dispersion layer and the wetted catalyst surface (i.e. after step (d)).

The backing layer provides support for the ion-conducting membrane during manufacture and if not immediately removed, can provide support and strength during any subsequent storage and/or transport. The material from which the backing layer is made should provide the required support, preferably be compatible with the first dispersion, preferably be impermeable to the first dispersion, be able to withstand the process conditions involved in producing the catalyst-coated ion-conducting membrane and be able to be easily removed without damage to the catalyst-coated ion-conducting membrane. Examples of materials suitable for use include a fluoropolymer, such as polytetrafluoroethylene (PTFE), ethylene tetrafluoroethylene (ETFE), perfluoroalkoxy polymer (PFA), fluorinated ethylene propylene (FEP—a copolymer of hexafluoropropylene and tetrafluoroethylene), and polyolefins, such as biaxially oriented polypropylene (BOPP). Other examples include laminates, multi-layer extrusions and coated films/foils capable of retaining their mechanical strength/integrity at elevated temperatures, for example temperatures up to 200° C. Examples include laminates of: poly(ethylene-co-tetrafluoroethylene) and polyethylene naphthalate (PEN); polymethylpentene (PMP) and PEN; polyperfluoroalkoxy (PFA) and polyethylene terephthalate (PET) and polyimide (PI). The laminates can have two or more layers, for example ETFE-PEN-ETFE, PMP-PEN-PMP, PFA-PET-PFA, PEN-PFA, FEP-PI-FEP, PFA-PI-PFA and PTFE-PI-PTFE. The layers may be bonded using an adhesive, such as acrylic or polyurethane.

The catalyst-coated ion-conducting membrane manufactured using the above method can also be used in the manufacture of a membrane-seal assembly, and a membrane electrode assembly as is known in the art.

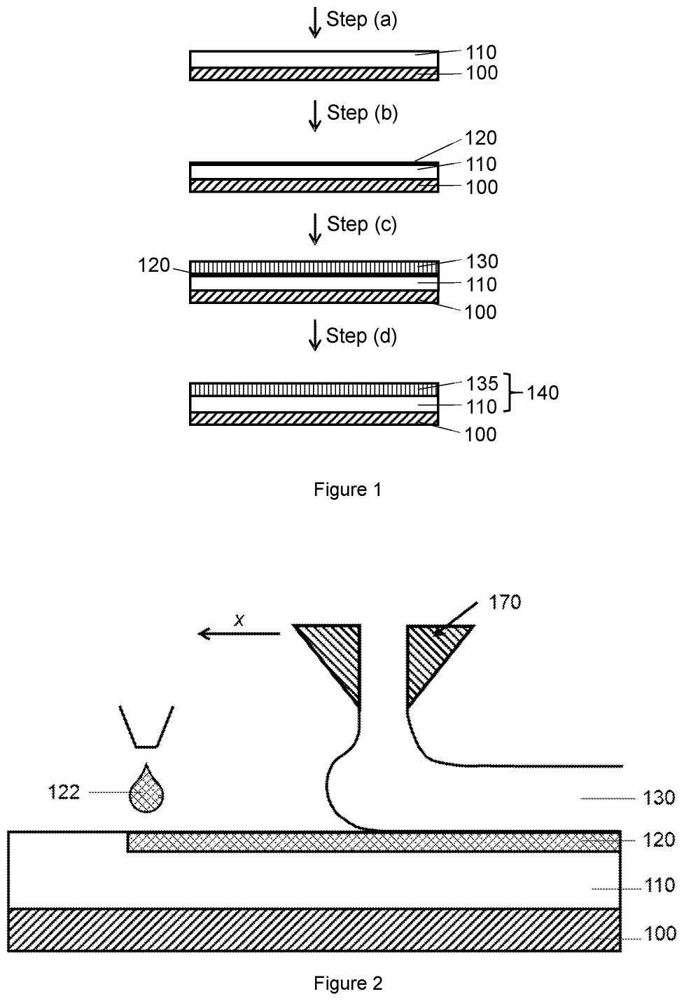

FIGS. 1 to 5 depict exemplary methods of the present invention. The dimensions (e.g. thickness) of each layer are not drawn to scale for the sake of clarity.

Referring to FIGS. 1 and 2, a backing layer 100 with a catalyst layer 110 on the backing layer is provided (step (a)). The catalyst layer 110 has a porous surface.

A wetting solution 122 is applied to the catalyst layer 110, for example by spray coating (step (b)). In this embodiment, the wetting solution consists of 80 wt. % ethanol and 20 wt. % water (based on the total weight of the wetting solution). The wetting solution spontaneously wets the catalyst layer 110 with a high degree of wetting (e.g. with a contact angle of less than 90°). The wetting solution impregnates the pores of the catalyst layer 110 to form a wetted catalyst surface 120.

A first dispersion is deposited onto the wetted catalyst surface 120 to form a first dispersion layer 130 on top of the wetted catalyst surface 120 (step (c)). The first dispersion comprises an ion-conducting polymer, such as a proton conducting polymer, in an amount of about 17 wt. %, based on the total weight of the first dispersion. The first dispersion has a continuous phase comprising 80 wt. % ethanol and 20 wt. % water, based on the total weight of the continuous phase. Without wishing to be bound by any theory or conjecture, it is believed that by at least partially filling the pores of the catalyst layer with the wetting solution, the first dispersion is prevented from penetrating into the catalyst layer. As such, the wetting solution acts as a blocking layer, and the first dispersion forms a discrete layer 130 on top of the catalyst layer 110. Advantageously, mixing between the first dispersion layer 130 and the wetted catalyst surface 120 is minimal. Therefore, unwanted reactions between the catalyst in the catalyst layer 110 and the first dispersion are reduced.

The first dispersion can be deposited using a slot die coating process, as shown in FIG. 2. As the first dispersion is deposited onto the wetted catalyst surface 120, the slot die head 170 moves relative to the backing layer 100 in the direction of the arrow labelled x. Typically, the slot die head 170 is moved at a substantially constant speed during the deposition process, which can help afford a uniform coating thickness.

Subsequently, the first dispersion layer 130 and the wetted catalyst layer are dried (step (d)) to form a catalyst-coated ion-conducting membrane 140. Upon drying, the wetting solution preferably evaporates without leaving a residue in the catalyst layer 110. Upon drying, the first dispersion layer forms a layer of an ion-conducting membrane 135. The layer of ion-conducting membrane is electrically non-conductive. The catalyst-coated ion-conducting membrane 140 comprises the catalyst layer 110 and the ion-conducting membrane 135. The backing layer 100 can be removed from the catalyst layer 110 as desired.

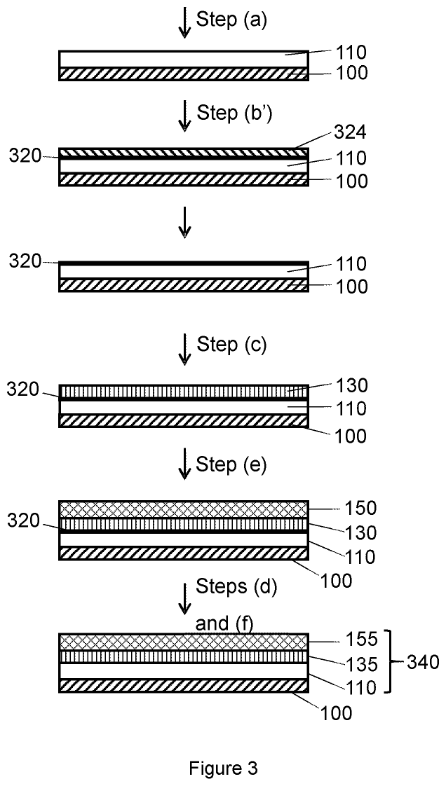

FIG. 3 shows a further embodiment of the present invention. The same reference signs have been used throughout the figures to refer to features and method steps which are identical.

A backing layer 100 with a catalyst layer 110 on the backing layer is provided (step (a)). The catalyst layer 110 has a porous surface.

An excess amount of wetting solution is applied to the catalyst layer 110, for example by spray coating (step (b′)). In this embodiment, the wetting solution consists of 90 wt. % ethanol and 10 wt. % water (based on the total weight of the wetting solution). The wetting solution spontaneously wets the catalyst layer 110 with a high degree of wetting (e.g. with a contact angle of less than 90°). The wetting solution impregnates and fully fills the pores of the catalyst layer 110 to form a wetted catalyst surface 320. The excess wetting solution forms a layer of wetting solution 324 on top of the wetted catalyst surface 320.

The layer of wetting solution 324 is subsequently removed, for example by an air knife, without drying the wetted catalyst surface 320.

Step (c) is performed in the same way as described in relation to FIGS. 1 and 2. After step (c), a second dispersion is deposited onto the first dispersion layer 130 to form a second dispersion layer 150 on the first dispersion layer 130 (step (e)). The second dispersion comprises an ion-conducting polymer. The second dispersion typically has a lower density than the first dispersion so that the second dispersion layer 150 floats on top of the first dispersion layer 130. The first and second layers 130, 150 form a layered structure. The wetted catalyst surface 320, the first dispersion layer 130 and the second dispersion layer 150 are subsequently dried, for example at 80° C., to form a catalyst-coated ion-conducting membrane 340 (steps (d) and (f)). Upon drying, the wetting solution preferably evaporates without leaving a residue in the catalyst layer 110. Upon drying, the first dispersion layer 130 forms a layer of an ion-conducting membrane 135. Upon drying, the second dispersion layer 150 forms a layer of an ion-conducting layer 155. The catalyst-coated ion-conducting membrane 340 comprises the catalyst layer 110, the dried ion-conducting layer 135 and the dried ion-conducting layer 155. The backing layer 100 can subsequently be removed, if desired. In other embodiments, the step of drying the first dispersion layer and wetted catalyst surface (step (d)) can be performed after step (c) and before step (e).

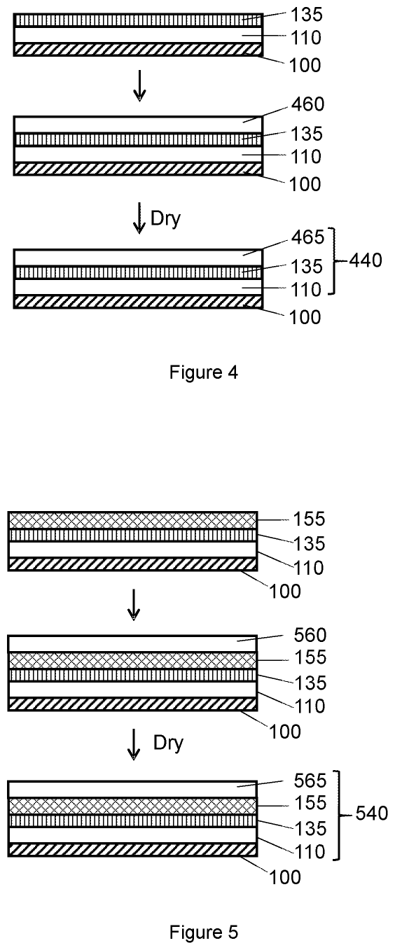

Any of the embodiments shown in FIGS. 1 to 3 can comprise the optional further steps of depositing a catalyst dispersion, and drying the catalyst dispersion to form a second catalyst layer. For example, FIG. 4 shows an embodiment in which a catalyst dispersion is deposited onto the ion-conducting membrane layer 135 to form a catalyst dispersion layer 460. The wet catalyst dispersion layer 460 is subsequently dried to form a second catalyst layer 465. Overall, a catalyst-coated ion-conducting membrane 440 is produced, which comprises a first catalyst layer 110, a second catalyst layer 465 and an ion-conducting membrane layer 135 disposed between the first and second catalyst layers 110, 465. The backing layer 100 can subsequently be removed, if desired.

FIG. 5 shows a further example in which a catalyst dispersion is deposited onto the dried second ion-conducting layer 155 to form a catalyst dispersion layer 560. The wet catalyst dispersion layer 560 is subsequently dried to form a second catalyst layer 565. Overall, a catalyst coated-ion-conducting membrane 540 is produced, which comprises (in order) a first catalyst layer 110, a first ion-conducting membrane layer 135, a second ion-conducting membrane layer 155, and a second catalyst layer 565. The backing layer 100 can subsequently be removed, if desired.

Further embodiments can comprise any number of ion-conducting membrane layers. Typically, each ion-conducting membrane layer is electrically non-conducting. Optionally, at least one of the ion-conducting layers can comprise a reinforcing component, such as an expanded polytetrafluoroethylene (ePTFE) material or a nanofibre network, such as a network comprising polybenzimidazole (PBI) fibres (not shown). The reinforcing component is typically added whilst the preceding dispersion layer is still wet so that the dispersion layer can at least partially impregnate into the reinforcing component. Alternatively, the reinforcing component can be impregnated with an ion-conducting polymer prior to positioning onto the previously deposited layer.

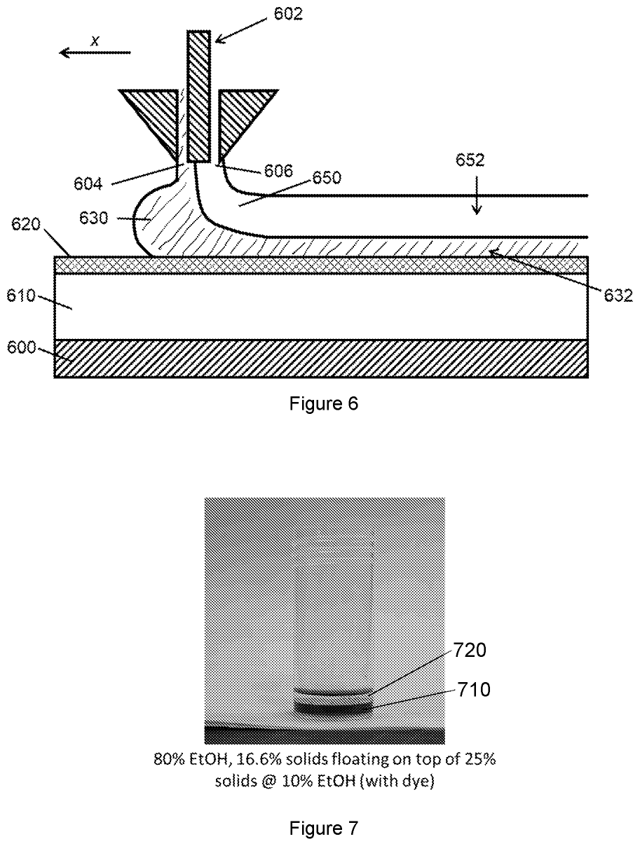

In any of the methods of FIG. 3 or 5, the first dispersion and the second dispersion can be deposited concurrently. That is, the second dispersion can be deposited onto the first dispersion layer whilst the first dispersion is still being deposited. FIG. 6 illustrates an exemplary method in which first and second dispersions are deposited concurrently. FIG. 6 illustrates a preferred dual head slot die coating process, although alternative coating techniques may be also used.

A backing layer 600 with a catalyst layer 610 on the backing layer is provided. The catalyst layer 610 is wetted with a wetting solution to form a wetted catalyst surface 620. The wetted catalyst surface 620 is positioned under a slot die head 602. The slot die head 602 is a dual slot die head comprising a first outlet 604 and a second outlet 606. A first dispersion 630 is deposited onto the wetted catalyst surface 620 via the first outlet 604. The first dispersion comprises an ion-conducting polymer. The first dispersion 630 forms a first wet dispersion layer 632. By way of example, the first dispersion 630 can have a continuous phase comprising 40 wt. % ethanol and 60 wt. % water (based on the total weight of the continuous phase).

A second dispersion 650 is deposited onto the first dispersion 630, whilst the first dispersion 630 is still wet, to form a second dispersion layer 652. The second dispersion comprises an ion-conducting polymer. By way of example, the second dispersion 650 has a continuous phase comprising 80 wt. % ethanol and 20 wt. % water (based on the total weight of the continuous phase). The first dispersion 630 has a higher density than the second dispersion 650. The second dispersion 650 floats on top of the first dispersion layer 632. The mixing between the first and second dispersions is minimal if unperturbed.

As the first and second dispersions are deposited, the slot die head 602 moves relative to the wetted catalyst surface 620 in the direction marked x. Typically, the slot die head 602 is moved at a substantially constant speed during the deposition process, which can help afford a uniform coating thickness.

The first and second layers 632, 652 can be dried simultaneously to afford a first ion-conducting layer and a second ion-conducting membrane layer respectively.

The present method allows multiple layers of a ion-conducting membrane to be deposited concurrently without exposing the membrane materials to high temperatures. This can significantly improve the efficiency of the manufacturing process, and can help to reduce the number of defective products.

Examples 1 to 3 show that two dispersions with different physical properties can form discrete and stable layers.

### Example 1

A first dispersion 710 comprising 10 wt. % ethanol and 90 wt. % water (based on the total weight of the continuous phase), 25 wt. % ionomer (based on the total weight of the first dispersion) was added to a sample vial. A dye was also added to the first dispersion 710 for ease of identification purposes. The dye did not otherwise materially affect the properties of the dispersion.

A second dispersion comprising 80 wt. % ethanol and 20 wt. % water (based on the total weight of the continuous phase) and ˜17 wt. % ionomer (based on the total weight of the second dispersion) was added dropwise so that the drops ran down the side wall of the sample vial. The second dispersion had a lower density than the first dispersion. The second dispersion 720 formed a discrete layer on top of the first dispersion 710, as shown in FIG. 7.

The layered structure was metastable. The layered structure could be irreversibly disrupted by applying a shear (mixing) force. However, the layers remained stable for up to 48 hours if unperturbed.

### Example 2

A first dispersion 810 comprising 10 wt. % ethanol and 90 wt. % water (based on the total weight of the continuous phase), 25 wt. % ionomer (based on the total weight of the first dispersion) was added to a sample vial. A dye was also added to the first dispersion for ease of identification purposes. The dye did not otherwise materially affect the properties of the dispersion.

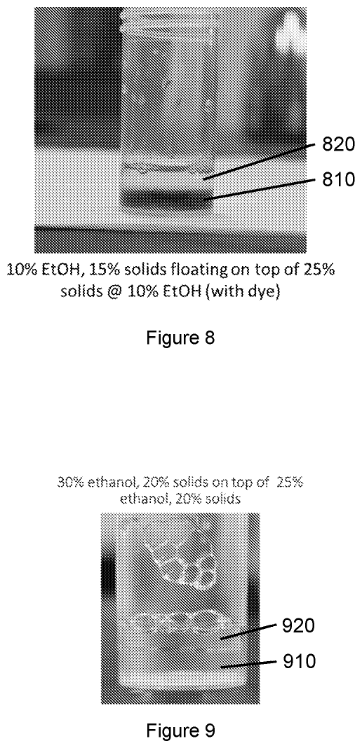

A second dispersion comprising 10 wt. % ethanol and 90 wt. % water (based on the total weight of the continuous phase) and 15 wt. % ionomer (based on the total weight of the second dispersion) was added dropwise so that the drops ran down the side wall of the sample vial. The second dispersion had a lower ionomer concentration than the first dispersion. The second dispersion 820 formed a discrete layer on top of the first dispersion 810, as shown in FIG. 8.

The layered structure was metastable. The layered structure could be irreversibly disrupted by applying a shear (mixing) force. However, the layers remained stable for up to 48 hours if unperturbed.

### Example 3

A first dispersion comprising 25 wt. % ethanol and 75 wt. % water (based on the total weight of the continuous phase), 20 wt. % ionomer (based on the total weight of the first dispersion) was added to a sample vial.

A second dispersion comprising 30 wt. % ethanol and 70 wt. % water (based on the total weight of the continuous phase) and 20 wt. % ionomer (based on the total weight of the second dispersion) was added dropwise so that the drops ran down the side wall of the sample vial. The second dispersion had a lower density than the first dispersion. The second dispersion 920 formed a discrete layer on top of the first dispersion 910, as shown in FIG. 9.

The layered structure was metastable. The layered structure could be irreversibly disrupted by applying a shear (mixing) force. However, the layers remained stable for up to 48 hours if unperturbed.

### Example 4

A catalyst layer was prepared on a backing layer using known methods. For example, a known catalyst ink can be coated onto a skive PTFE backing layer using a slot die coating process, screen printing or other known method. The layer of catalyst ink is dried to remove the solvent and form a porous dried catalyst layer on the PTFE backing layer.

The dried catalyst layer was sprayed/soaked with a wetting solution. The wetting solution spontaneously wetted the surface of the catalyst layer. The wetting solution comprised ethanol, although other low boiling point alcohols, such as propan-1-ol and isopropyl alcohol, are also suitable. The concentration of the alcohol in the wetting solution was 80 wt. % (based on the total weight of the wetting solution), which was suitably high to spontaneously wet the surface of the catalyst layer and form a wetted catalyst surface.

An excess amount of the wetting solution was applied so that a layer of wetting solution resided on top of the catalyst layer. The excess wetting solution was subsequently removed using an air knife. Only the excess layer of wetting solution was removed. The wetting solution that had impregnated the pores of the catalyst layers was not removed.

A first dispersion comprising an ion-conducting polymer was deposited onto the wetted catalyst surface using a slot die coating process. The first dispersion comprised ˜17 wt. % ion-conducting polymer (based on the total weight of the first dispersion). The first dispersion had a continuous phase of 80 wt. % ethanol and 20 wt. % water, based on the total weight of the continuous phase. The first dispersion formed a first dispersion layer on the wetted catalyst surface.

The first dispersion layer and wetted catalyst surface were dried simultaneously at 80° C. The first dispersion layer remained as a substantially discrete layer on top of the catalyst layer, but these layers were intimately bonded.

1. A method of manufacturing a catalyst-coated ion-conducting membrane, the method comprising the steps of:
(a) providing a catalyst layer on a backing layer, wherein the catalyst layer comprises pores;
(b) applying a wetting solution to the catalyst layer, wherein the wetting solution impregnates at least some of the pores of the catalyst layer so as to form a wetted catalyst surface;
(c) depositing a first dispersion onto the wetted catalyst surface to form a first dispersion layer on the wetted catalyst surface, wherein the first dispersion comprises an ion-conducting polymer; and,
(d) drying the first dispersion layer and the wetted catalyst surface after step (c).

2. The method according to claim 1, wherein the wetting solution impregnates at least 70%, preferably at least 80%, and more preferably at least 90% of the pores of the catalyst layer.

3. The method according to claim 2, wherein the wetting solution impregnates all of the pores of the catalyst layer.

4. The method according to claim 1, wherein the wetting solution forms a layer of wetting solution on top of the catalyst layer, and the method further comprises the step of at least partially removing the layer of wetting solution whilst retaining the wetting solution within the pores prior to the step of depositing the first dispersion.

5. The method according to claim 1, wherein the wetting solution comprises water, a polar solvent other than water, or a mixture thereof.

6. The method according to claim 5, wherein the wetting solution is: water and methanol; water and ethanol; water and propan-1-ol; water and isopropyl alcohol; ethanol, propan-1-ol, or isopropyl alcohol.

7. The method according to claim 5, wherein the wetting solution comprises the polar solvent other than water in an amount in the range of >70 wt. %, preferably 75-90 wt. %, or more preferably 80-85 wt. % based on the total weight of the wetting solution.

8. The method according to claim 1, wherein the wetting solution has a degree of wetting towards the catalyst layer that is higher than the degree of wetting of the first dispersion towards the catalyst layer.

9. The method according to claim 1, wherein the first dispersion comprises a continuous phase comprising water, a polar solvent other than water, or a mixture thereof.

10. The method according to claim 9, wherein the continuous phase of the first dispersion comprises the polar solvent other than water in an amount in the range of <90 wt. %, preferably 10-85 wt. %, or more preferably 20-80 wt. %, based on the total weight of the continuous phase.

11. The method according to claim 1, further comprising the steps of:
(e) depositing a second dispersion onto the first dispersion to form a second dispersion layer on the first dispersion layer, wherein the second dispersion comprises an ion-conducting polymer;
wherein step (d) comprises drying the first dispersion layer, the second dispersion layer and the wetted catalyst surface after step (e).

12. The method according to claim 1, further comprising the steps of:
depositing a catalyst dispersion; and,
drying the catalyst dispersion to form a second catalyst layer;
wherein the first dispersion layer is disposed between the catalyst layer and the second catalyst layer.

13. The method according to claim 1, wherein step (a) comprises the sub-steps of:
depositing a catalyst dispersion onto the backing layer; and,
drying the catalyst dispersion to form the catalyst layer.

14. The method according to claim 1, further comprising the steps of removing the backing layer from the catalyst layer after step (d).

15. A method of manufacturing a membrane-seal assembly, the method comprising the steps of:
providing a catalyst-coated ion-conducting membrane manufactured using the method according to claim 1, the catalyst-coated ion-conducting membrane comprising a first face and a second face; and,
applying a seal material to the first face and/or the second face of the catalyst-coated ion-conducting membrane.

16. A method of manufacturing a membrane electrode assembly, the method comprising the steps of:
providing a catalyst-coated ion-conducting membrane manufactured using the method according to claim 1, the catalyst-coated ion-conducting membrane comprising a first face and a second face; and,
applying a gas diffusion layer onto the first and/or second faces of the catalyst-coated ion-conducting membrane.

17-18. (canceled)
